(19) United States
(12) Patent Application Publication
(10) Pub. No.: US 2025/0032961 A1
(43) Pub. Date: Jan. 30, 2025

(54) Filter Apparatus

(71) Applicant: HYDAC FluidCareCenter GmbH, Sulzbach / Saar (DE)

(72) Inventors: Edwin Koch, Tholey (DE); Timo Lang, Neunkirchen (DE); Daniel Müller, Neunkirchen (DE); Martin Noll, Ingbert (DE)

(73) Assignee: HYDAC FluidCareCenter GmbH, Sulzbach / Saar (DE)

(21) Appl. No.: 18/836,106

(22) PCT Filed: Oct. 25, 2022
(86) PCT No.: PCT/EP2022/079720

§ 371 Date: Aug. 6, 2024

(30) Foreign Application Priority Data
Feb. 10, 2022 (DE) 10 2022 000 510.7

(51) Int. Cl. B01D 29/58; B01D 29/11; B01D 29/21; B01D 39/18

(52) U.S. Cl. CPC B01D 29/58; B01D 29/112; B01D 29/21; B01D 39/18; B01D 2201/12; B01D 2201/291

(57) ABSTRACT

A filter apparatus consists of a combination of various filter elements combined to form a structural unit, one filter element of these filter elements serving to clean of particles and another filter element to clean oil oxidation products from a fluid stream, the filter elements being mounted in parallel to each other for the respective cleaning of the fluid stream.

### CROSS-REFERENCE TO RELATED APPLICATIONS

This application claims priority to German Patent Application No. DE 10 2022 000 510.7, filed on Feb. 10, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter apparatus. Such filter apparatuses serve, when inserted in a filter housing, to clean supplied contaminated fluid, for example in the form of a hydraulic medium, of particulate contamination by using the filter material of a filter element and to return the fluid cleaned in this manner from the filter housing into the fluid circuit, in particular hydraulic circuit. If the filter material: is clogged with contamination in this manner after a plurality of filter cycles, it is spent and the filter element needs to be removed from the apparatus housing and replaced with a new element for further operation.

### SUMMARY

A need exists to provide an improved filter apparatus. The need is addressed by the subject matter of the independent claim(s). Embodiments of the invention are described in the dependent claims, the following description, and the drawings.

### BRIEF DESCRIPTION OF THE DRAWINGS

FIG. 1 shows an example filter apparatus in its entirety in the form of a longitudinal section;

FIG. 2 shows a side view of a modified embodiment of the filter apparatus of FIG. 1;

FIG. 3 shows a perspective oblique view of a further modified embodiment of the filter apparatus of FIGS. 1 and 2; and

FIG. 4 shows a general parallel mounting of the filter apparatus of FIGS. 1 to 3 in the form of a hydraulic circuit diagram; incorporated in a hydraulic supply circuit shown by way of a simplified drawing with a motor pump unit and a storage tank.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the filter apparatus consists of a combination of various/different filter elements combined to form a structural unit, one of these filter elements serving to clean particles or solid contaminants respectively and another filter element to clean oil oxidation products (varnish) from a fluid stream, the filter elements being mounted in parallel to each other for corresponding cleaning of the fluid stream. In this manner, this makes it possible to divide the fluid stream to be processed and in each case to actuate the respective filter element with the specific cleaning option in a predefinable distribution ratio. This way the fluid stream can be processed in a particularly efficient way. Such filter apparatuses are generally part of hydraulic supply circuits with the result that a fluid that is already treated by the structural unit can be resupplied to the filter apparatus once again as part of the circulation process. Furthermore, the oil oxidation products or varnish respectively are generally not listed in literature as ‘hard’ particles, with the result that these do not represent particulate contamination in the actual sense; instead, these generally take the form of a slurry-like contamination of the fluid stream.

It is for example provided that the filter elements form the structural unit by lying on top of one another and, with their respective element material, separate an unfiltered medium side from a filtrate side, which is surrounded by the respective element material. In this manner, it is possible to achieve a continuous inflow along the entire outer circumferential side of the structural unit and throughflow with the fluid stream to be processed over the entire filter element surface in the same manner.

In some embodiments of the filter apparatus, it is provided that the filter element comprises a pleated, for example multi-layered element material for particle cleaning, wherein the filter element is formed by individual annular discs lying on top of one another to receive the oil oxidation products, said discs consisting at least partially of cellulose, for example completely of cellulose. Due to the pleating of the element material, the surface for the filter element is enlarged accordingly such that solid particles can be cleaned from the fluid stream to a large extent. While the filter elements consisting of cellulose in the prior art are also used predominantly for particle cleaning (EP 3 334 512 B1) or serve to separate water from the oil fluid stream (WO 2018/082799 A1), according to the teachings herein, the annular discs containing cellulose are used to clean oil oxidation products (varnish), wherein, when the fluid passes through, the cellulose fibres, as is also the case in the prior art, still have a coalescing effect, the emulsion containing oil from the water portion forming enlarged drops, which sink to the bottom due to the difference in density between water and oil, resulting accordingly in separation of the less dense medium and water is thus separated from the hydraulic medium.

In some embodiments of the filter apparatus, it is provided that the structural unit formed by the filter elements in each case comprises an end cap at the ends, one of said end caps sealing the filter element for particle cleaning at the bottom and the other end cap, sealing the filter element for cleaning oil oxidation products at the top, comprising a through opening for the filtrate stream. In this manner, the structural unit in its entirety is a replacement product which can be exchanged for a new, unused structural unit when the filter element material is spent as part of a complete apparatus.

In some embodiments of the filter apparatus, it is provided that at least one constriction or aperture point is provided on the filtrate side of the structural unit, said point dividing the fluid volume stream between the individual filter elements in a predefinable ratio. As the cellulose material often forms the denser cleaning medium compared to the pleated filter element material, the flow resistance for the cellulose element is thus increased such that, in order to ensure a simultaneous, uniform throughflow of the structural unit on the filtrate side, the constriction or aperture point is arranged on the filtrate side, for example at the fluid outlet of the filter element for particle filtration and at the adjacent inlet of the filter element for cleaning oil oxidation products. In this manner, the flow resistance at the outlet of the particle filter element can be increased in the direction of the filtrate discharge side for the particle filter such as to achieve a uniform fluid throughflow for both superimposed filter elements.

The constriction or aperture point is in this case arranged in a particularly space-saving manner in an intermediate cap between one filter element and the other filter element.

In some embodiments of the filter apparatus, it is provided that all filter discs with the cellulose material have the same filter properties, in particular the same filter grade. The annular filter discs are all constructed in the same manner with regard to their element material. In this manner, a kind of stack structure or stacking sequence is achieved, wherein the filter discs can be stacked on top of one another as identical components in a predefinable number according to the respective filtration task in order to thus achieve a varnish element with a predefinable structural height.

To ensure an improved inflow with low turbulence, it is provided in some embodiments that the individual annular filter discs have recesses on their outer circumferential side which are formed by incisions, indentations or adjacent spacers between the filter discs.

The aforementioned filter discs made from cellulose are manufactured using the so-called Rapid Köthen method in accordance with DIN EN ISO 5269-2 and a high level of process reliability during manufacture is achieved as a correspondingly standardised method.

The filter apparatus is explained in greater detail in the following with reference to examples of embodiments according to the drawings, which are in outline and not to scale. Specific references to components, process steps, and other elements are not intended to be limiting.

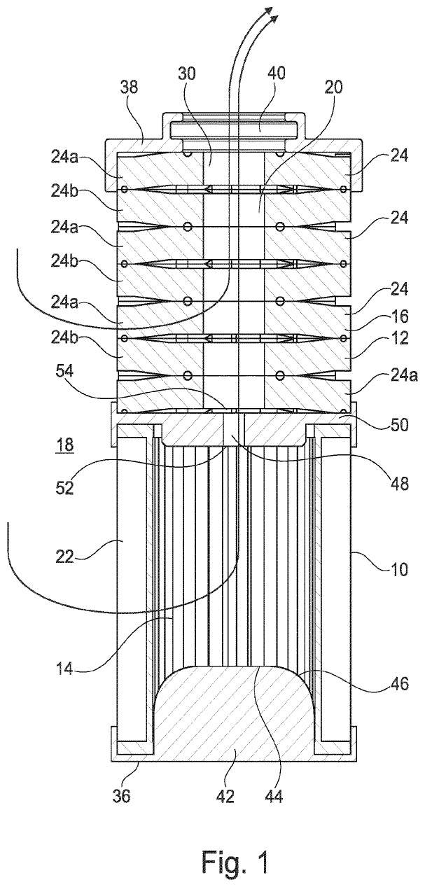

FIG. 1 shows the filter apparatus in its entirety, which thus forms a structural unit and an assembled combination of two different filter elements 10, 12, one filter element 10 primarily serving to clean particles and another filter element 12 primarily serving to clean oil oxidation products (varnish) from a fluid stream, wherein the fluid guidance is shown as a line on FIG. 1, with arrows at the ends to represent the throughflow direction. Accordingly, the flow thus passes from the outside to the inside of the filter apparatus in its entirety. The depicted arrows and the path of the line also make it clear that the two filter elements 10, 12 are mounted parallel to one another for corresponding cleaning of the fluid stream. The fluid to be cleaned may arise from a hydraulic medium or hydraulic oil respectively but also from another fluid which is accessible for the aforementioned cleaning.

The filter apparatus shown in FIG. 1 consists only of two filter elements 10, 12; however, selection of a different arrangement with further filter elements (not shown) is possible within the scope of the apparatus solution according to the teachings herein.

FIG. 1 shows the usual operating position for the filter apparatus and the filter elements 10, 12 form the structural unit by lying on top of one another and, with their respective element material 14, 16, separate a so-called unfiltered medium side 18 from a filtrate side 20, which is surrounded in a hollow cylindrical manner by the respective element material 14, 16. In the arrangement shown in FIG. 1, the other filter element 12 is arranged above the first filter element 10; however, it is generally also possible to rotate the corresponding arrangement if necessary (not shown). The illustrated arrangement is, however, particularly beneficial with respect to the throughflow behaviour of the fluid, which is explained in more detail below.

The filter element 10 for particle cleaning comprises a pleated, for example multi-layered element material 14. The multi-layered structure of such an element material 14 or filter medium may, for example, have the following laminar structure from one side to the other side:
1. Metal wire cloth or synthetic fabric or plastic mesh with net structure,
2. Polyester nonwoven,
3. Fibreglass mat or meltblown nonwoven
4. Paper nonwoven, fibreglass mat or meltblown nonwoven
5. Polyester nonwoven
6. Stainless steel polyester blended fabric, metal wire cloth or synthetic fabric or plastic mesh with net structure.

It should be stressed at this juncture that the corresponding layer structure is only given by way of example, but this has proven to be particularly effective in connection with particle filtration. However, it is also possible to use a different structure, in which it is particularly beneficial to provide a prefilter layer in front of a main filter layer, when viewed in the throughflow direction of the fluid. It can also be beneficial for a support function of the individual filter pleats if these are formed with different pleat heights, wherein pleats with a lower pleat height are for example interconnected between pleats with a correspondingly taller pleat height. Furthermore, the star-pleated filter layer in the form of the element material 14 can usually be supported on a hollow cylindrical perforated support tube 22.

The filter element 12 for receiving oil oxidation products or varnish respectively consists of individual annular discs 24 which form a stack or stacking sequence when laid on top of one another. The corresponding discs consist at least partially of cellulose, but these are for example constructed completely from cellulose material.

As is shown in FIG. 1 in particular, the individual filter discs 24 in an embodiment may also be formed by part-halves 24a, 24b, which, between them, viewed diametrically with respect to the longitudinal axis of the structural unit, have recesses 26 of the same shape lying opposite one another, said recesses being formed by notch-like incisions or indentations in the filter discs 24 or by two filter disc halves 24a, b of a respective filter disc 24 being arranged adjacent to one another. In addition, further recesses 28, which are configured according to the recesses 26, are located in the stack sequence between the filter discs 24 accordingly. The respective recess 26, 28 thus runs from a rectangular central region tapering in a wedge-like manner at the edges into the respective filter disc 24, or into the adjacently arranged disc halves 24a, b. The aforementioned recesses 26, 28 in the form of incisions or indentations are only arranged on the upper side of the respective element material 16 and, as is shown in particular in FIG. 1, do not engage in the hollow cylindrical inner chamber 30 of the filter element 12, which thus also forms the filtrate side 20 of the filter apparatus.

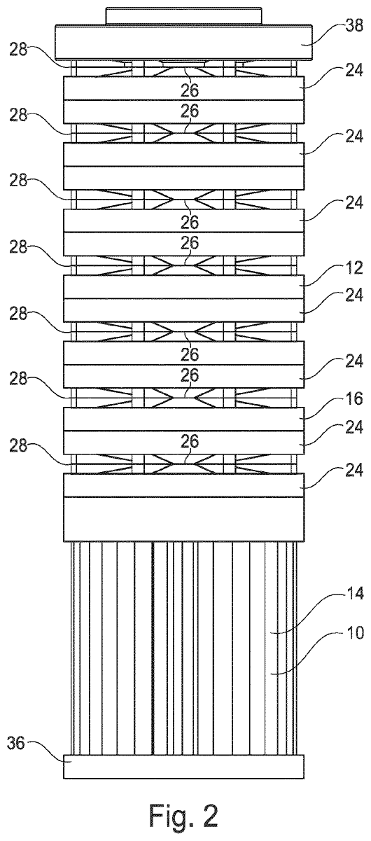

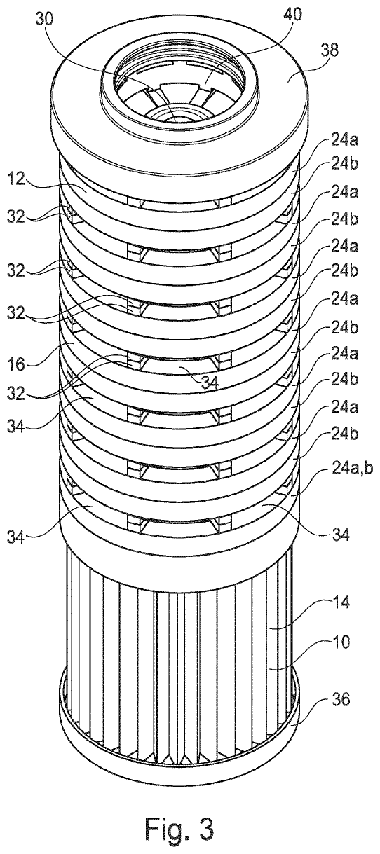

In the accordingly modified embodiment according to FIG. 2, the recesses 26, 28 are formed by correspondingly circumferential-side indentations or incisions, wherein, in any event, the recesses 26, 28 reinforce the stability of the cellulose element in its entirety and serve to provide improved flow guidance for the unfiltered material stream from outside into the inner chamber 30 of the filter element 12. In any event, four recesses 26, 28 each lying in a common radial plane are present on each filter disc or between the disc halves 24a, 24b of a filter disc 24. In particular, the disc-shaped element material 16, which is configured to be closed up to its porous region, is formed by a filter blank, which originates from the sheet former. In the embodiment according to FIG. 3, the individual filter discs 24 forming individual disc halves 24a, b with each other comprise radially extending limiting rods facing each other as spacers 32, which between them delimit recesses 34, which, in turn, serve to provide an improved channel-like fluid guidance; however, in turn, they do not pass completely through the filtering element material 16, comparable to the recesses 26, 28 according to the embodiments described previously. The discs 24 arranged on top of one another in this manner serve to clean oil oxidation products from the fluid stream in accordance with the arrow-line drawing according to FIG. 1. Accordingly, a simultaneous parallel inflow to both filter elements 10, 12 takes place from the unfiltered medium side 18 to the filtrate side 20.

As is also shown in FIG. 1, the disc 24 arranged at the very bottom, as viewed on the FIG., is only half provided in the form of a part half 24a. As is also shown on FIGS. 1 to 3, the structural unit formed by the filter elements 10, 12 comprises an end cap 36, 38 at the ends in each case, one 36 of said end caps sealing the filter element 10 for particle cleaning at the bottom and the other end cap 38, sealing the filter element 12 for cleaning oil oxidation products at the top, comprising a through opening 40 for discharging the filtrate stream from the filter apparatus. As shown on FIG. 1, the lower base cap 36 may comprise a flow guide device 42 to improve flow guidance, said device protruding into the filtrate side 20 of the filter element 10. In this case, the flow guide device 42 is formed by a solid block, which comprises a delimitation plane 44 on its end face, which runs transversely with respect to the longitudinal axis of the filter apparatus, and which emerges at its edges into a surrounding edge 46 running in a convex manner which is delimited from the outside by the support tube 22. The height of the flow guide device 42 is for example ⅕ to ¼ of the structural height of the filter element 10 for particle cleaning.

As is also shown on FIG. 1, a constriction or aperture point 48 is provided in the centre on the filtrate side 20 of the structural unit, said point dividing the fluid volume stream between the individual adjacent filter elements 10, 12 in a predefinable ratio according to the selected free cross-sectional area. The constriction or aperture point 48 is arranged in an intermediate cap 50 between one filter element 10 and the other filter element 12. In particular, the constriction or aperture point 48 is arranged at the fluid outlet 52 of the filter element 10 for particle filtration and at the accordingly adjacent inlet 54 of the filter element 12 for cleaning oil oxidation products and thus on the filtrate side 20.

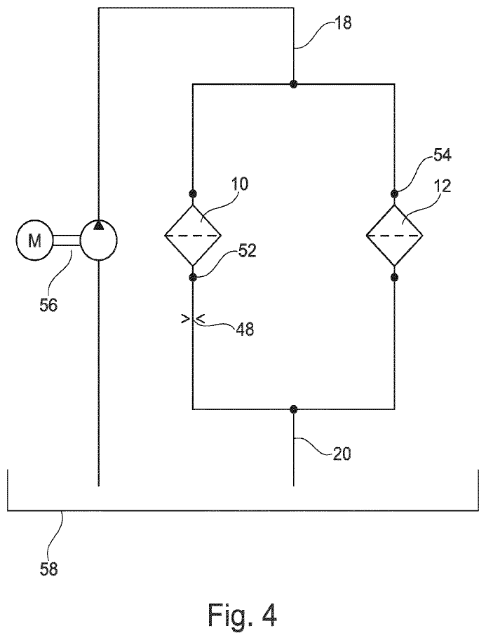

In FIG. 4, the primary function of the constriction or aperture point 48 is shown in more detail by means of a hydraulic supply circuit with a motor pump unit 56. This motor pump unit 56 takes hydraulic fluid from a storage tank 58 and supplies both filter elements 10, 12 equally with fluid as part of the aforementioned parallel mounting, wherein, as already explained, the constriction or aperture point 48 is arranged at the outlet 52 of the filter element 10, as viewed in the fluid flow direction, for particulate contamination. As part of the aforementioned parallel mounting, constricting the fluid stream at the outlet 52 of the filter element 10 thus influences the fluid supply at the inlet 54 of the filter element 12. As part of the simplified representation according to FIG. 4, the filtrate stream leads back into the storage tank 58 on the filtrate outlet side of both filter elements 10, 12; in practice, however, hydraulic components such as hydraulic operating valve cylinders, devices, hydraulic accumulators, etc, for example, are generally connected to the filtrate side 20 of the filter apparatus, which require cleaned fluid from the filter apparatus if they are to operate correctly. In this case the overall resistance value R_{ges} is as follows:

$$\frac{1}{\sqrt{{R}_{ges}}} = \frac{1}{\sqrt{{R}_{1}}} + \frac{1}{\sqrt{{R}_{2}}}$$

where R₁ and R₂ is the respective individual resistance of a partial branch with the corresponding filter element 10, 12. This leads to an overall volume flow V by using the following formula:

$$V = \sqrt{\frac{Δ p}{{R}_{ges}}}$$

where Δp is the overall pressure loss for the filter apparatus.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A filter apparatus comprising a combination of different filter elements combined to form a structural unit, a first filter element of the filter elements configured to clean particles and a second filter element of the filter elements to clean oil oxidation products from a fluid stream, the filter elements being mounted in parallel to each other for the respective cleaning of the fluid stream.

12. The filter apparatus of claim 11, wherein the filter elements form the structural unit by being arranged on top of each other and, with their respective element material, separate an unfiltered medium side from a filtrate side, which is surrounded by the respective element material.

13. The filter apparatus of claim 11, wherein the filter element comprises a pleated element material for particle cleaning and wherein the filter element is formed by individual annular discs arranged on top of one another to receive the oil oxidation products, said discs consisting at least partially of cellulose.

14. The filter apparatus of claim 11, wherein the structural unit formed by the filter elements in each case comprises an end cap at the ends, one of said end caps sealing the filter element for particle cleaning at the bottom and the other end cap, sealing the filter element for cleaning oil oxidation products at the top, comprising a through opening for the filtrate stream.

15. The filter apparatus of claim 11, wherein at least one constriction or aperture point is provided on the filtrate side of the structural unit, said point dividing the fluid volume stream between the individual filter elements in a predefinable ratio.

16. The filter apparatus of claim 15, wherein the constriction or aperture point is arranged at the fluid outlet of the filter element for particle filtration and at the adjacent inlet of the filter element for cleaning oil oxidation products on the filtrate side.

17. The filter apparatus of claim 15, wherein the constriction or aperture point is arranged in an intermediate cap between one filter element and the other filter element.

18. The filter apparatus of claim 11, wherein all filter discs with the cellulose material have the same filter properties, and wherein the annular filter discs are all constructed in the same manner with regard to their element material.

19. The filter apparatus of claim 11, wherein the individual annular filter discs have recesses on the outer circumferential side which are formed by incisions, indentations or by adjacent spacers between the filter discs.

20. The filter apparatus of claim 11, wherein the filter element comprises an element material, which element material is closed disc-shaped and is formed by a filter blank.

21. The filter apparatus of claim 11, wherein the filter element comprises a pleated, multi-layered element material for particle cleaning.

22. The filter apparatus of claim 11, wherein the filter element is formed by individual annular discs arranged on top of one another to receive the oil oxidation products, said discs consisting completely of cellulose.

23. The filter apparatus of claim 12, wherein the filter element comprises a pleated element material for particle cleaning and wherein the filter element is formed by individual annular discs arranged on top of one another to receive the oil oxidation products, said discs consisting at least partially of cellulose.

24. The filter apparatus of claim 12, wherein the structural unit formed by the filter elements in each case comprises an end cap at the ends, one of said end caps sealing the filter element for particle cleaning at the bottom and the other end cap, sealing the filter element for cleaning oil oxidation products at the top, comprising a through opening for the filtrate stream.

25. The filter apparatus of claim 13, wherein the structural unit formed by the filter elements in each case comprises an end cap at the ends, one of said end caps sealing the filter element for particle cleaning at the bottom and the other end cap, sealing the filter element for cleaning oil oxidation products at the top, comprising a through opening for the filtrate stream.

26. The filter apparatus of claim 12, wherein at least one constriction or aperture point is provided on the filtrate side of the structural unit, said point dividing the fluid volume stream between the individual filter elements in a predefinable ratio.

27. The filter apparatus of claim 13, wherein at least one constriction or aperture point is provided on the filtrate side of the structural unit, said point dividing the fluid volume stream between the individual filter elements in a predefinable ratio.

28. The filter apparatus of claim 14, wherein at least one constriction or aperture point is provided on the filtrate side of the structural unit, said point dividing the fluid volume stream between the individual filter elements in a predefinable ratio.

29. The filter apparatus of claim 16, wherein the constriction or aperture point is arranged in an intermediate cap between one filter element and the other filter element.

30. The filter apparatus of claim 11, wherein all filter discs with the cellulose material have the same filter grade, and wherein the annular filter discs are all constructed in the same manner with regard to their element material.
